(19) United States
(12) Patent Application Publication
(10) Pub. No.: US 2006/0083823 A1
(43) Pub. Date: Apr. 20, 2006

(54) Process for producing fermentation feedstock from extruded cereal material

(76) Inventors: Eugene J. Fox, Dayton, OH (US); Suhas K. Mehra, Miamisburg, OH (US); Aharon M. Eyal, Jerusalem (IL); James T. Walsh II, Dayton, OH (US); Eugene M. Peters JR., Kettering, OH (US); Donald L. Shandera JR., Ashland, NE (US); Rod R. Fisher, Eden Prairie, MN (US)

Correspondence Address: CARGILL, INCORPORATED, LAW/24, 15407 MCGINTY ROAD WEST, WAYZATA, MN, 55391, US

(21) Appl. No.: 10/521,122

(22) PCT Filed: Jul. 22, 2003
(86) PCT No.: PCT/US03/22949

§ 371 Date: Aug. 17, 2005

Related U.S. Application Data
(60) Provisional application No. 60/397,986, filed on Jul. 23, 2002.

(51) Int. Cl. A23B 7/10

(52) U.S. Cl. 426/49

(57) ABSTRACT

There is disclosed a process for producing a fermentation feedstock from a cereal material that is extruded. The cereal material extrudate is liquefied and separated into streams. Furthermore, of the liquefied extrudate may be saccharified.

This application claims priority of Provisional Application Ser. No. 60/397,986 filed Jul. 23, 2002, the entire contents of which are incorporated herein by reference.

### FIELD OF INVENTION

The present invention related to a process for producing a fermentation feedstock.

### BACKGROUND

Most corn processed in the United States is treated by the wet milling process. This process includes a 24-48 hour chemical steeping of the corn followed by grinding, filtration, and high-speed centrifugation using copious amounts of water to separate fiber, germ, protein, and starch. Traditionally, the germ is subsequently processed to vegetable oil, and the protein and fiber are used for animal, avian, or fish feed, and the starch is used for many purposes such as sweetener or alcohol production.

The process of extrusion is well known in the art. For example, the use of extrusion to promote degradation and liquefaction of starch within cereal grain to provide a feedstock for alcoholic fermentation has been reported. The extrudate may be processed further by exposure to enzymes or heat.

While the process of extrusion is well known in the art, typically, the extruded product is not separated after extrusion. The development of a process that uses extrusion to facilitate separation of a cereal material into various product streams would be desirable.

### SUMMARY OF THE INVENTION

The present invention relates to producing a fermentation feedstock from a cereal material that is extruded, wherein the extrudate is liquefied. The liquefied extrudate is separated into two or more streams. Optionally the liquefied extrudate may be saccharified. Optionally, the protein of one or more streams may be hydrolyzed.

The present process is further related to using the extruded, liquefied, and separated cereal material in the production of a fermentation feedstock. Furthermore, the present process is related to using the extruded, liquefied, and separated cereal material as a fermentation feedstock.

### DETAILED DESCRIPTION OF THE INVENTION

The present invention relates to producing a fermentation feedstock from a cereal material that is extruded, wherein the extrudate is liquefied. The liquefied extrudate is separated into two or more streams. Optionally the liquefied extrudate may be saccharified. Optionally, the protein of one or more streams may be hydrolyzed.

The present process is further related to using the extruded, liquefied, and separated cereal material in the production of a fermentation feedstock. Furthermore, the present process is related to using the extruded, liquefied, and separated cereal material as a fermentation feedstock.

The process described herein relates to a method for producing a fermentation feedstock from an extruded cereal material. Extrusion includes introducing the cereal material into an extruder and passing the cereal material through the extruder. The extruder includes a die through which the extrudate exits. The cereal material is subjected to heat and pressure in the extruder.

The term cereal material herein may be any cereal material and includes whole products and parts thereof. Examples of suitable cereal material includes material derived from corn, oats, barley, rye, wheat, rice, sorghum, other millets, or a mixture thereof.

The present process is also related to optionally treating the cereal material with a fluid before and/or during extrusion. The fluid used herein may be, water, steam, an aqueous solution, an organic solution, or mixtures thereof. Preferred for use, however, is an aqueous solution. The organic solution can be an organic solvent that is selected from the group consisting of hexane, isohexane, ethanol, methanol, acetone, propanol, iso-propanol, butanol and mixtures thereof. The treated cereal material may then be extruded to form the extrudate.

In the present process, the cereal material may be further contacted with an agent prior to or during extrusion. Agents suitable for contacting the cereal material include reducing agents, enzymes, and acids. Suitable reducing agents include sulfur dioxide, salts of sulfite, and the like. The fluid may contain enzymes that are intended to hydrolyze particular fiber, protein, or carbohydrate. Suitable enzymes may include cellulases, hemicellulases, proteases, amylases, and glucoamylases. Examples of proteases include Bromelain. The fluid may have an acidic pH. Typically, the pH of the fluid may range from about 1 to about 7, from about 1 to about 4 and most preferably about 1.5 to about 2.5. Suitable acids include sulfuric acid, sulfurous acid, hydrochloric acid, a carboxylic acid, and a mixture thereof. Examples of carboxylic acid include acetic acid, oxalic acid, malonic acid, sucinic acid, malic acid, lactic acid, citric acid, gluconic acid, and a mixture thereof.

Processing of the corn material may be influenced by conditions within the extruder obvious to those skilled in the art. For example, the pressure and temperature within the barrel may be regulated. The pressure within the barrel may be regulated by controlling the volume of corn material introduced into the barrel or by introducing additional material into the barrel such as an aqueous processing solution. Additionally, the pressure, residence time, and shear may be adjusted by flight, screw, and barrel configuration. The temperature within the barrel may be adjusted to facilitate processing of the corn material as well. Depending on the temperature and pressure differences across the die, the surface area of the extrudate is increased to a level that exceeds the surface area of the corn material before extrusion.

The extruder preferably has a short length, high speed, and a short retention time. In regard to rotation speed, the extruder preferably operates at a speed of at least 700 RPM, and preferably greater than 1000 RPMC. In regard to the extruder's dimension, the extruder preferably has a length to diameter ratio of less than 12 and preferably around 5-7. During extrusion, the corn material preferably has a retention time of no more than about 10 seconds. Energy input to the extruder is commonly about 100-250 W-hr/kg (155-387 BTU/lb).

The temperature of the extruder may be regulated to control processing. For example, the cereal material may be extruded under conditions in which the cereal material is heated preferably to about 120° C. to 280° C. in the extruder.

Generally, the process involves extruding a cereal material to form an extrudate, which includes protein, fiber, oil, and starch. The extrudate is liquefied to form a liquefied extrudate, which includes protein, fiber, oil, and liquefied starch. The liquefied extrudate then is separated to provide one or more streams that include a protein and fiber-containing stream and/or a liquefied starch stream. It may be desirable to treat the liquefied extrudate to provide a saccharified extrudate, which includes saccharified starch. It may be also desirable to treat the liquefied extrudate to provide a degraded material, which includes liquefied starch material, fiber, oil, and hydrolyzed protein. The process may also involve extruding a cereal material to form an extrudate that is introduced into an aqueous liquid in a chamber. The aqueous liquid may include an enzyme, such as alpha-amylase, and/or an acid. To promote liquefaction of the extrudate, the aqueous solution may contain acid, base, and/or enzymes, such as a protease or an amylase.

Separation processes may be used to provide insoluble or soluble streams, for example a “liquefied starch stream” or “liquefied starch material.” As defined herein, “liquefied starch stream” and “liquefied starch material” may be defined as amylaceous material that has at least been substantially hydrolyzed and may have been further converted into smaller oligosaccharides and/or high DE materials such as dextrose. As defined herein, “saccharification” refers to enzymatic conversion of long chain or cross-linked carbohydrates into smaller oligosaccharides by enzymes such as amylases. A measure of saccharification can be obtained by calculating the amount of free aldehyde groups relative to the molecular weight of the sample. This is commonly characterized as the “dextrose equivalents” or “DE” of a carbohydrate derived material.

To facilitate liquefaction, the aqueous solution within the chamber may include an alpha-amylase, or the aqueous solution may have an acid pH. For example, a pH of 1.5-6.0 may be desirable. Also, where desirable, the aqueous solution within the chamber may be heated to a temperature of at least about 80° C. to facilitate further hydrolysis of the starch-containing material. Where the aqueous solution is in a closed chamber to allow greater than atmospheric pressures, the aqueous solution may be heated to temperatures of up to about 150° C.

As an example of a method for producing a fermentation feedstock, the following is provided. The starch comprising extrudate produced by the previously described extrusion processes may be optionally hydrolyzed to form a fermentation feedstock to be incorporated into the fermentation media. The extrudate may be hydrolyzed to any extent to form a hydrolyzed starch, including to dextrose. The extrudate slurry may be hydrolyzed by any manner. For example, extrudate may be hydrolyzed by subjecting the extrudate to acid hydrolysis. Typically acids will include inorganic acids such as hydrochloric acid and the like. Elevated temperatures increase the rate of hydrolysis and may be varied over a wide range depending on the degree of hydrolysis desired. Acid hydrolysis is limited in the extent of starch hydrolysis possible. If one wishes to exceed that level of hydrolysis, one must use other means of hydrolysis such as enzymatic digestion of the starch with starch hydrolyzing enzymes.

An exemplary process for carrying out starch liquefaction by acid hydrolysis is described as follows:
a) The extrudate has water added to from a 40% dry solids solution;
b) the pH of the slurry is adjusted to 1.8 with 22 Baumé hydrochloric acid;
c) the slurry with pH 1.8 is introduced into a converter at 295° F. for 18 minutes; and
d) the converted starch is then pH to 4.8 with 10% soda ash and cooled, with a hydrolysis to 85 DE is achieved.

An exemplary process for starch hydrolysis by enzyme/enzyme hydrolysis is described as follows:

Hydrolysis of starch is performed in the following steps of 1) liquefaction and 2) optionally, saccharification.

Enzyme liquefaction: Water is added to the extrudate to adjust dry solid content to 35%. The pH of slurry is adjusted to 5.5 using sodium hydroxide solution. Calcium chloride is added to the slurry to have the minimum of 5 ppm of free calcium. Termamyl Supra (TERMAMYL SUPRA™ amylase enzyme, available from Novozymes North America, Inc) is added to this pH adjusted slurry at the amount of 0.4 liter per metric ton of starch dry solids. Then, the mixture is heated in a continuous jet cooker to 108° C. and held for 5 minutes in a pressurized vessel. Then the cooked mixture is cooled to 95° C. and held for 100 minutes. Hydrolysate with a DE of 8 to 12 is achieved at this point.

The current process may also further comprise saccharifying said liquefied starch. Saccharification: Starch hydrolysate from the above liquefaction step is cooled to 60° C. and the dry solid content is adjusted to 32% by adding water. The pH of this diluted hydrolysate is adjusted to 4.1-4.3 using sulfuric acid. DEXTROZYME E™ Enzyme a trademarked (mixture of amyloglucosidase and pullunase available from Novozymes North America, Inc) is added at the amount of 0.7 liters per metric ton of dry solids and then the mixture is held for 40 hours. Dextrose content of 95-97%, on the dry solid basis, is achieved.

Further information regarding starch hydrolysis is found in Technology of Corn Wet Milling and Associated Processes p. 217-266, Paul H. Blanchard, Elsevier Science Publishers B. V. Amsterdam.

After the cereal material has been liquefied, the liquefied material may be separated into two or more streams; for example, a protein and fiber-containing stream and/or a liquefied starch-containing stream, and these separated streams may be further separated to provide subsequent streams with desirable properties. Separation may involve filtration, (for example, screening with a pressure feed screen and/or separation using a microfilter or cloth belt), centrifugation, (that is centrifugal separation), and/or extraction. The liquefied cereal material or separated streams may be treated to promote hydrolysis of components. For example, the liquefied material or separated streams may be treated with acid, base, or enzymes such as proteases to provide hydrolyzed protein, or amylases to provide liquefied starch or saccharified starch.

Processing of the extrudate may include separation of the liquefied cereal material, and components thereof, into various streams. Examples of streams include an oil-containing stream (for example, germ stream), a protein-containing stream (for example, gluten stream), a starch-containing stream, or any combination thereof. These streams may be directed to downstream operations for further processing (for example, production of fermentation feedstock). Alternatively these streams may be directed to side streams for further processing or disposal (for example, oil extraction, production of animal feed or fermentation feedstock).

Where desirable, the protein and fiber-containing stream may be separated to provide a protein-enriched stream and a fiber-enriched stream, for example, by screening or centrifugation. The protein and fiber-containing stream or the protein-enriched stream may be treated further to provide a hydrolyzed protein-containing stream, for example by treating the protein and fiber-containing stream or the protein-enriched stream with a protease. As defined herein, “hydrolyzed protein” may be defined as proteinaceous material that has been partially reduced smaller polypeptides and amino acids. The amount of smaller polypeptides and amino acids can be represented by measuring the amount of soluble protein within a protein solution (wt. %) at a given pH. A measure of the free amino acid percentage within the protein solution can be obtained by calculating the amount of free amino groups relative to the molecular weight of the sample, herein defined as “FAN.” The nitrogen to FAN ratio is about 5 or less. The hydrolyzed protein-containing stream may be combined with the saccharified material to form a nitrogen-enriched fermentation feedstock.

In a first embodiment, the process includes extruding cereal material to form an extrudate, which includes protein, fiber and liquefied starch. Using for example corn, the corn is cleaned by passing the corn through screens, which removes trash and optionally broken corn and fine material. The cleaned corn is then transferred to an extruder.

Water may be added to adjust the moisture of the corn and to modify the morphology of the extrudate. The corn material may be extruded under conditions that include contacting the corn material with an aqueous solution to form a tempered cereal material and extruding the tempered cereal material to form the extrudate. The aqueous solution may have an acid pH, for example, a pH of about 1.0 to about 7. To obtain an acid pH, the aqueous solution may contain sulfuric acid, sulfurous acid, hydrochloric acid a carboxylic acid, or a mixture thereof. Where carboxylic acid is chosen, the carboxylic acid may include acetic acid, oxalic acid, malonic acid, sucinic acid, malic acid, lactic acid, citric acid, gluconic acid, and a mixture thereof. Where desirable, the cereal material may be treated with sulfur dioxide or salts of bisulfite.

In this first embodiment, it may be desirable to form a liquefied extrudate that includes protein, fiber and liquefied starch. To promote liquefaction, the extrudate may be cut by a cutting mechanism after it passes through the extruder and exits through a die. The temperature of the die is maintained at least about 120° C. and no more than about 280° C. As the extrudate passes through the die, it expands and enters an aqueous bath. The density of the extrudate is commonly about 10-200 g/L. After the extrudate has entered the aqueous solution, the aqueous solution containing the extrudate is transferred to a first holding vessel. To promote liquefaction of the extrudate, the aqueous solution may contain acid, base, and/or enzymes, such as a protease or an amylase.

After the extrudate has been liquefied to any desirable level, the liquefied extrudate is separated to provide a protein and fiber-containing stream and a starch-containing stream, for example, by filtration with a rotary vacuum filter. The separated streams may be further treated to provide subsequent streams with desirable properties. For example, the starch-containing stream may be treated with a glucoamylase to promote starch breakdown. The amount of starch breakdown may be determined by calculating the DE. The saccharified material which includes saccharified starch and has a DE of at least about 20. To facilitate saccharification, the cereal material may be extruded in the presence of a glucoamylase. Any remaining solids may be removed from the saccharified solution, for example, by filtration through a membrane filter. It may be desirable to obtain an oil-enriched stream by extracting the remaining solids with a solvent to recover oil.

In another embodiment a second process for producing a fermentation feedstock from cereal material is provided. The process includes extruding cereal material to form an extrudate, which includes protein, fiber, and starch. In this embodiment, the extrudate is liquefied to form a liquefied extrudate which includes protein, fiber and liquefied starch. The liquefied extrudate is further treated to provide a degraded material which includes liquefied starch material, fiber and hydrolyzed protein. For example, the liquefied extrudate may be treated with a protease to hydrolyzed. Where desirable, the degraded material may be separated to provide a solids stream, which includes fiber, and a soluble stream, which includes hydrolyzed protein and liquefied starch material. The soluble stream may be saccharified to provide a saccharified stream which includes soluble protein and has a DE of at least about 20.

In another embodiment, the liquefied extrudate is also saccharified before separating. The liquefied saccharified material has a DE of at least about 20. Fiber is separated from the extruded, liquefied, and saccharified material with a 5 stage screen separation system arranged such that the fiber is washed in a counter current flow of fiber to clean water, where the cleanest fiber is washed with the cleanest water added to the screen system. Washed fiber is discharged at the last stage (fifth stage), while starch and protein containing slurry is discharge at the first stage. The screen opening on the first fiber wash stage is 50 micron, followed by 75 micron on the second, 100 micron on stages 34, and 150 micron of the last stage. The washed fiber is dewatered using screw presses, and dried using a rotary drier, resulting in the dried fiber product. The de-fibered stream is then treated with a protease. The protein is hydrolyzed until the nitrogen to FAN ratio is about 5 or less.

In another embodiment, a forth process for producing a fermentation feedstock from cereal material is provided. The process includes extruding cereal material to form an extrudate, which includes protein, fiber, and starch. After extrusion, the extrudate is liquefied to form a liquefied extrudate which includes protein, fiber and liquefied starch. In this embodiment, the liquefied extrudate is separated to provide a protein and fiber-containing stream and a liquefied starch-containing stream. The process may also include saccharifying the liquefied starch stream to provide a saccharified material which includes saccharified starch and has a DE of at least about 20. To facilitate saccharification, the cereal material itself may be extruded in the presence of an amylase. The saccharified extrudate may then be separated to provide a protein and fiber-containing stream and a saccharified starch-containing stream.

In this embodiment, the protein and fiber-containing stream may be extracted with a solvent. The solvent selected from the group consisting of hexane, isohexane, ethanol, methanol, acetone, propanol, iso-propanol, butanol and mixtures thereof, and separating to provide an oil containing solvent stream and an oil-depleted component stream. The oil-depleted, protein and fiber stream may be treated with a protease to form a protease-treated stream that includes hydrolyzed protein. The insoluble solids within this protease-treated stream may be removed to provide a hydrolyzed protein containing stream, for example, by filtration or centrifugation. This hydrolyzed protein containing stream then may be combined with a portion of the saccharified material to form a nitrogen-enriched fermentation feedstock.

In this embodiment, the cereal material may be contacted steam followed by a solution containing sodium bisulfite prior to extrusion to form a tempered cereal material, and the tempered cereal material then may be extruded to form the extrudate. The process may include extruding the cereal material under conditions which heat the cereal material to about 120° C. to 280° C., and the process may include extruding the cereal material through an extruder under conditions such that the volume of the cereal material expands, desirably by about 50%.

To facilitate liquefaction, the aqueous solution within the chamber may include an alpha-amylase, or the aqueous solution may have an acid pH. For example, a pH of 1.5-6.0 may be desirable. Also, where desirable, the aqueous solution within the chamber may be heated to a temperature of at least about 80° C. to facilitate further hydrolysis of the starch-containing material. Where the aqueous solution is in a closed chamber to allow greater than atmospheric pressures, the aqueous solution may be heated to temperatures of up to about 150° C.

In another embodiment, insoluble or soluble streams may be combined to provide subsequent streams with desirable characteristics. For example, a hydrolyzed protein-containing stream may be combined with saccharified material to form a nitrogen-enriched fermentation feedstock. The relative amounts of carbohydrate and nitrogen can be represented by a “C/N” ratio. The nitrogen-enriched fermentation feedstock has a C/N ratio of about 15 or less.

The following examples are presented to illustrate the present invention and to assist one ordinarily skilled in making and using the same. The examples are not intended in any way to otherwise limit the scope of the invention.

### EXAMPLES

### Example 1

Corn is cleaned by passing the corn through screens, which removes trash and optionally broken corn and fine material. Water, with lactic acid added, having a pH of 3.4, adjusted with sulfuric acid, is added to adjust the moisture of the corn to 25%. The cleaned corn is then transferred to an extruder.

In regard to rotation speed, the extruder is operated at a speed of about 850 RPM. In regard to the extruder's dimension, the extruder has a length to diameter ratio of about 6. Within the extruder, the corn should have a retention time of around 5 seconds. Energy input to the extruder is about 175 W-hr/k-g (about 271 BTU/lb).

The corn is heated to about 200° C. during extrusion. As the extrudate passes out of the die directly into an aqueous bath that includes amylase, it expands and is cut into pieces with a submerged cutter mounted on the end of the die. The density of the extrudate is about 55 g/L.

The extrudate is transferred to a holding vessel. Water is added to the extrudate to adjust dry solid content to 35%. The pH of slurry is adjusted to 5.5 using sodium hydroxide solution. Calcium chloride is added to the slurry to have the minimum of 5 ppm of free calcium. TERMAMYL SUPRA enzyme, (a trademarked amylase available from Novozymes North America, Inc) is added to this pH adjusted slurry at the amount of 0.4 liter per metric ton of starch dry solids. The mixture is allowed to cooled to 95° C. (203° F.) and held for 100 minutes. Starch molecule breakdown in the vessel occurred such that the DE level reached 8. The aqueous solution is separated from the coarse solids by passing the aqueous solution through a series of five pressure feed screen with about 75 micron slots. Fresh or cycled aqueous solution flows counter currently to the fiber to increase recovery of aqueous solution. The coarse solids are retained and dried, and the clarified aqueous solution is passed to a second holding vessel. The clarified aqueous solution is cooled to 60° C. and the dry solid content is adjusted to 32% by adding water. The pH of this diluted hydrolysate is adjusted to 4.1-4.3 using sulfuric acid. DEXTROZYME E enzyme (a trademarked mixture of amyloglucosidase and pullunase available from Novozymes North America, Inc) is added at the amount of 0.7 liters per metric ton of dry solids and then the mixture is held for 40 hours. Dextrose content of 95-97%, on the dry solid basis, is achieved. The saccharified solution containing dextrose then is clarified of remaining solids using a membrane filter. The sacrharified solution is retained for a fermentation feedstock. The retentate from the membrane filtering is treated with an protease to hydrolyze the protein. The hydrolyzed solution is then separated from the solids on a rotary vacuum filter. The solids from the rotary vacuum filter are combined with the dried fiber. The dried solids then are extracted with a solvent to recover oil. The hydrolyzed protein stream is retained for a fermentation feedstock.

### Example 2

Corn is extruded as in Example 1. The extrudate is discharged into an aqueous bath containing proteases, and the aqueous solution is passed to a holding tank. After the proteins have been hydrolyzed to a level where the total nitrogen to FAN ratio of no more than about 5. Any insoluble solids including insoluble protein and fiber are separated from the aqueous solution by filtering the solution through screens as in Example 1. As in Example 1, additional aqueous solution is recovered by rinsing the insoluble solids through stage rinses on pressure feed screens with fresh or cycled aqueous solution. The insoluble solids are dried and retained.

Glucoamylase is then added to the clarified aqueous solution, and the aqueous solution is then saccharified until the level of reducing sugars reaches 80%.

### Example 3

The process of example 1 is followed except that wheat is substituted for the corn. It is expected that similar results will be obtained.

### Example 4

Corn are extruded as in Example 1. The extrudate is discharged directly into an aqueous bath containing amylase, and the aqueous solution containing the extrudate is passed to a holding vessel until starch molecule breakdown in the vessel occurred such that the DE level reached 8. Glucoamylase is then added and the material is saccharified. After the material has been saccharified until the level of reducing sugars reaches 95%, a protease is added to hydrolyze the protein to amino acid and polypeptides, until the FAN level is about 4. After the desired level of protein breakdown has occurred, insoluble solids are separated from the aqueous solution by filtering the material with a rotary vacuum filter.

### Example 5

Corn is extruded as in Example 1. The extrudate is discharged into an aqueous bath containing amylase. The extrudate is transferred to a holding vessel and liquefied as in Example 1. After starch hydrolysis in the vessel occurred such that the DE level reached 10, the aqueous solution is separated from the course solids as in Example 1. Glucoamylase is added to the clarified aqueous solution, and the solution is saccharified until the level of reducing sugars reaches 90%.

The solids are separated by with a Merco H36 centrifuge. This centrifuge operates at 2600 rpm and is fitted with No. 24 size nozzle. The underflow, containing an concentrated protein stream is placed into a holding tank containing an aqueous solution of protease. After the proteins have been hydrolyzed to a level where the total nitrogen to FAN ratio of no more than about 5, the aqueous solution and remaining solids are separated as in Example 1. The clarified, amino acid and polypeptide solution is then retained for fermentation. The removed solids are dried and optionally extracted with solvent to recover oil. A portion of the saccharified solution is combined with a portion of the hydrolyzed protein stream to have a C/N ratio of about 14.

The method has been described with reference to various specific embodiments and techniques. The examples described herein illustrate but do not limit the scope of the invention that has been set forth herein. It should be noted that the description of various embodiments provided in the this disclosure may be of overlapping scope. The embodiments discussed in this disclosure are merely illustrative and are not meant to limit the scope of the present invention, or equivalents thereof. It should be understood that many variations and modifications may be made while remaining within the spirit and scope of the invention.

1. A process for treating a cereal material comprising:
extruding the cereal material to form an extrudate comprising starch and a component selected from the group consisting of protein, fiber, and a mixture thereof;
liquefying the starch in the extrudate; and
separating the extrudate into at least two or more streams comprising one or more components selected from a group consisting of liquefied starch, oil, protein, fiber, and mixtures therefore.

2. The process of claim 1 further comprising saccharifying said liquefied starch.

3. The process of claim 2 wherein the liquefied starch is saccharified prior to separation.

4. The process of claim 1 further comprising hydrolyzing protein.

5. The process of claim 1, wherein at least one of said streams comprises liquefied starch and protein, and further comprising saccharifying said liquefied starch and hydrolyzing said protein.

6. The process of claim 2 further comprising hydrolyzing protein of a protein containing stream and combining at least a portion of the hydrolyzed protein and at least a portion of the saccharified starch.

7. The process of claim 2 wherein the saccharified starch has a DE of at least about 20.

8. The process of claim 3 wherein the saccharified starch has a DE of at least about 20.

9. The process of claim 4 wherein the protein is hydrolyzed with a protease.

10. The process of claim 6 wherein the hydrolyzed protein has a total nitrogen to FAN ratio not greater than about 5.

11. The process of claim 1 wherein the extruding of the cereal material comprises passing the cereal material through an extruder that operates at a speed of at least 700 RPM with an energy input to the extruder of about 100-250 W-hr/kg; wherein the extruder has a length to diameter ratio of no more than about 12, and wherein the cereal material is retained in the extruder for no more than about 10 seconds.

12. The process of claim 1 wherein the cereal material is extruded in the presence of an acid.

13. The process of claim 12 wherein the acid is selected from the group consisting of sulfuric acid, sulfurous acid, hydrochloric acid, a carboxylic acid, and a mixture thereof.

14. The process of claim 13 wherein the carboxylic acid is selected from the group consisting of acetic acid, oxalic acid, malonic acid, sucinic acid, malic acid, lactic acid, citric acid, gluconic acid, and a mixture thereof.

15. The process of claim 1 wherein the cereal material is extruded in the presence of an amylase.

16. The process of claim 1 wherein the cereal material is extruded at a temperature from about 120 to about 280° C.

17. The process of claim 1 wherein the cereal material is contacted with a fluid selected from a group consisting of water, steam, or an aqueous solution.

18. The process of claim 1 wherein the cereal material is contacted with sulfur dioxide and or salts of sulfite.

19. The process of claim 17 wherein the cereal material is contacted with an aqueous solution having a pH of less than 7.

20. The process of claim 1 further comprising contacting a component selected from the group consisting of fiber, oil, protein, starch, and mixtures thereof with a solvent selected from the group consisting of hexane, isohexane, ethanol, methanol, acetone, propanol, iso-propanol, butanol and mixtures thereof, and separating the stream to provide an oil containing stream and an oil-depleted stream.

21. A fermentation feedstock product produced in accordance with the process of claim 1 having a carbon to nitrogen ratio not greater than about 15.

22. A fermentation feedstock product produced in accordance with the process of claim 4 having a carbon to nitrogen ratio not greater than about 15.

23. A fermentation feedstock product produced in accordance with the process of claim 5 having a carbon to nitrogen ratio not greater than about 15.

24. A process for producing a fermentation feedstock comprising using the product of claim 1.

25. A process for producing a fermentation feedstock comprising using the product of claim 8.

26. A process for using the product of claim 24 as a fermentation feedstock.

27. A process for using the product of claim 25 as a fermentation feedstock.

28. A fermentation feedstock produced according to claim 24.

29. A fermentation feedstock produced according to claim 25.

30. The process according to claim 20 further comprising recovering an oil product from the oil containing stream.
